(19) United States
(12) Patent Application Publication
(10) Pub. No.: US 2006/0220479 A1
(43) Pub. Date: Oct. 5, 2006

(54) Hybrid vehicle driving system

(75) Inventor: Kunio Hasegawa, Saitama (JP)

Correspondence Address: ARENT FOX KINTNER PLOTKIN & KAHN, PLLC, Suite 400, 1050 Connecticut Avenue, N.W., Washington, DC, 20036-5339, US

(73) Assignee: Honda Motor Co., Ltd.

(21) Appl. No.: 11/392,630

(22) Filed: Mar. 30, 2006

(30) Foreign Application Priority Data
Mar. 30, 2005 (JP) P.2005-097154

(51) Int. Cl. H02K 5/10; H02K 5/12

(52) U.S. Cl. 310/85

(57) ABSTRACT

A holding frame is configured to include a substantially annular frame main body made of an electromagnetic shielding material in which a resolver stator is installed, a flange portion on which bolt mounting holes are provided in such a manner as to face to communicate with bolt mounting holes on a cylinder block, and an extending portion which extends radially outwardly from the frame main body in such a manner as to follow a laying path of harnesses and on which a bolt mounting hole is provided. The extending portion of the holding frame is disposed in such a manner as to be interposed between the harnesses and a connector portion, and stator windings of a motor in such a state that an internal combustion engine and the motor are direct connected to each other in series, so as to electromagnetically shield the harnesses and the connector portion when the stator windings are energized.

The present application claims foreign priority based on Japanese Patent Application No. 2005-097154, filed Mar. 30, 2005, the content of which is incorporated herein by reference.

### BACKGROUND OF THE INVENTION

1. Technical Field

The present invention relates to a hybrid vehicle driving system and a method for fabricating the hybrid vehicle driving system.

2. Related Art

Conventionally, there has been known a shielding sheath construction in which a shielding sheath material is wound around only a predetermined area of a wiring harness (for example, refer to JP-A-11-353952).

Incidentally, when fabricating a shielding sheath construction according to the aforesaid related-art example, some labor hours are necessary to carry out complex and troublesome work of winding a shielding sheath material around a wiring harness, and during this winding work, work is also necessary of winding an independent ground wire together with the shielding sheath material in such a manner that the ground wire lies inside of the shielding sheath material so wound. Furthermore, when mounting the wiring harness around which the shielding sheath material is wound on an appropriate member, work is necessary of connecting the independent wire to a ground terminal, in addition to work of fixing the wiring harness. Thus, this series of pieces of work causes a problem where some labor hours are necessary for complex and troublesome work of fabricating and installing the shielding sheath construction, the number of processes required to fabricate and install the shielding sheath construction is increased, and the number of parts which make up the shielding sheath construction is increased. In particular, when the shielding sheath construction according to the related-art example is applied to a connecting wiring to a magnet pole position sensor included in a driving system of a hybrid vehicle on which an internal combustion engine and a motor are installed as drive sources, there is caused a need of securing space for work of laying and installing the wiring harness, leading to a risk where an axial length of the driving system is increased.

### SUMMARY OF THE INVENTION

The invention was made in view of the situations, and an object thereof is to provide a hybrid vehicle driving system which can suppress an increase in the number of components required to make up the driving system and can prevent the spending of many labor hours for complex and troublesome work when fabricating the system and a method for fabricating the hybrid vehicle driving system.

However, the present invention need not achieve the above object, and other objects not described herein may also be achieved. Further, the invention may achieve no disclosed objects without affecting the scope of the invention.

With a view to solving the problem so as to attain the object, according to a first aspect of the invention, there is provided a hybrid vehicle driving system which includes a motor (for example, a motor 12 of an embodiment) including a rotor (for example, a rotor 21 of the embodiment) which is disposed between an internal combustion engine (for example, an internal combustion engine 11 of the embodiment) and a transmission (for example, a transmission T of the embodiment) to be connected thereto, the hybrid vehicle driving system including a magnet pole position sensor (for example, a magnet pole position sensor 13 of the embodiment) disposed between the internal combustion engine and the motor for detecting a magnet pole position of the rotor, a holding member (for example, a holding frame 33 of the embodiment) made of an electromagnetic shielding material for holding the magnet pole position sensor, and an extending portion (for example, an extending portion 43 of the embodiment) which extends from the holding member in such a manner as to be interposed between a connection wiring (for example, a harness 34 of the embodiment) of the magnet pole position sensor and a stator winding (for example, a stator winding 22a of the embodiment) of the rotor.

According to the hybrid vehicle driving system of the first aspect of the invention, since the extending portion which extends from the holding member which holds the magnet pole position sensor is disposed in such a manner as to be interposed between the connection wiring to the magnet pole position sensor and the stator winding of the motor, while suppressing an increase in the number of components required to make up the driving system and preventing the spending of many labor hours for complex and troublesome work when fabricating the system, the extending portion can physically protect the connection wiring to the magnet pole position sensor and can implement an electromagnetic shielding on the connection wiring to the magnet pole position sensor when the stator winding is energized.

Furthermore, according to a second aspect of the invention, there is provided a hybrid vehicle driving system as set forth in the first aspect of the invention, wherein the holding member includes a plurality of fastening portions (for example, bolt mounting holes 42a, . . . , 42a of the embodiment) which are fastened to be fixed to a main body of the internal combustion engine.

According to the hybrid vehicle driving system of the second aspect of the invention, while suppressing an increase in the number of components required to make up the driving system and preventing the spending of many labor hours for complex and troublesome work when fabricating the system, the magnet pole position sensor can be fixed to the internal combustion engine main body, and the holding member can be set so as to have the same electric potential as that of the internal combustion engine main body.

According to a third aspect of the invention, there is provided a method for fabricating a hybrid vehicle driving system which includes a motor (for example, the motor 12 of the embodiment) including a rotor (for example, rotor 21 of the embodiment) which is disposed between an internal combustion engine (for example, the internal combustion engine 11 of the embodiment) and a transmission (for example, the transmission T of the embodiment) to be connected thereto and a magnet pole position sensor for detecting a magnet pole position of the rotor, including the steps of fixing a holding member (for example, the holding frame 33 of the embodiment) made of an electromagnetic shielding material for holding the magnet pole position sensor (for example, the magnet pole position sensor 13 of the embodiment) to an internal combustion engine main body (for example, a cylinder block 11a of the embodiment), and fixing a motor housing (for example, a motor housing 12a of the embodiment) which accommodates the motor in an interior thereof to the internal combustion engine main body in such a manner that the magnet pole position sensor and the holding member are held from both sides by the internal combustion engine main body and the motor and that an extending portion (for example, the extending portion 43 of the embodiment) which extends from the holding member is interposed between a connection wiring (for example, the harness 34 of the embodiment) of the magnet pole position sensor and a stator winding (for example, the stator winding 22a of the embodiment) of the rotor.

According to the method for fabricating a hybrid vehicle driving system of the third aspect of the invention, while suppressing an increase in the number of components required to make up the driving system and preventing the spending of many labor hours for complex and troublesome work when fabricating the system, the connection wiring to the magnet pole position sensor can be protected physically and an electromagnetic shielding can be implemented on the connection wiring to the magnet pole position sensor when the stator winding is energized, whereby the holding member can be set so as to have the same electric potential as that of the internal combustion engine main body.

According to the hybrid vehicle driving system of the first aspect of the invention, while suppressing an increase in the number of components required to make up the driving system and preventing the spending of many labor hours for complex and troublesome work when fabricating the system, the connection wiring to the magnet pole position sensor can be physically protected and the electromagnetic shielding can be implemented on the connection wiring to the magnet pole position sensor when the stator winding is energized.

Furthermore, according to the hybrid vehicle driving system of the second aspect of the invention, the holding member can be set so as to have the same electric potential as that of the internal combustion engine main body.

In addition, according to the method for fabricating a hybrid vehicle driving system of the third aspect of the invention, while suppressing an increase in the number of components required to make up the driving system and preventing the spending of many labor hours for complex and troublesome work when fabricating the system, the connection wiring to the magnet pole position sensor can be protected physically and an electromagnetic shielding can be implemented on the connection wiring to the magnet pole position sensor when the stator winding is energized, whereby the holding member can be set so as to have the same electric potential as that of the internal combustion engine main body.

### BRIEF DESCRIPTION OF THE DRAWINGS

FIG. 1 is a sectional view which contains a rotational axis of a hybrid vehicle driving system according to an exemplary, non-limiting embodiment of the invention.

FIG. 2 is a plan view of a magnet pole position sensor shown in FIG. 1.

FIG. 3 is a sectional view taken along the line A-A shown in FIG. 2.

FIG. 4 is a perspective view which shows the magnet pole position sensor mounted on a cylinder block.

FIG. 5 is a perspective view of the magnet pole position sensor and a motor.

FIG. 6 is an enlarged perspective view of a main part of the magnet pole position sensor and the motor.

### DETAILED DESCRIPTION OF THE INVENTION

Hereinafter, an embodiment of a hybrid vehicle driving system of the invention will be described by reference to the accompanying drawings.

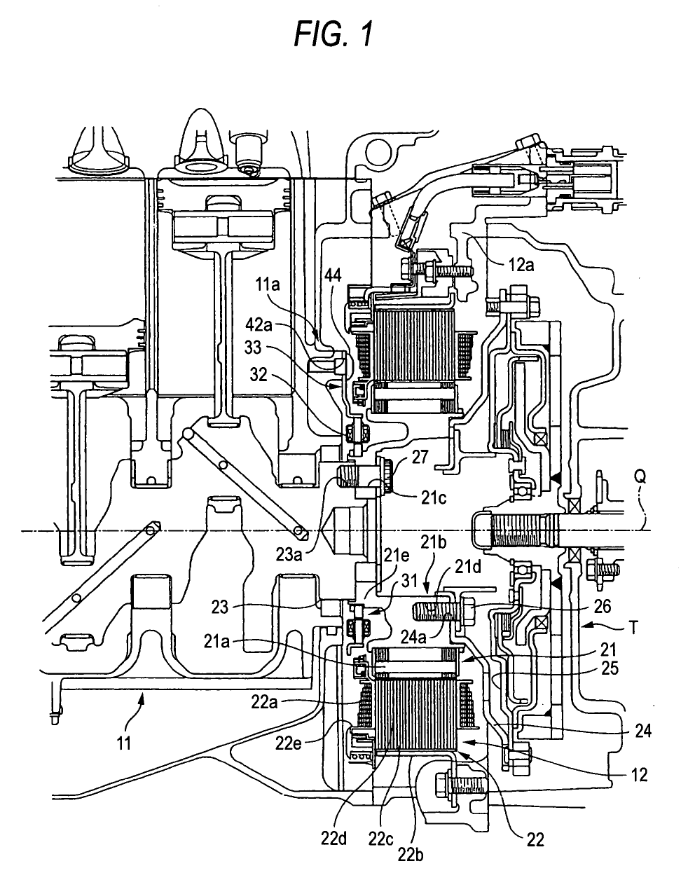

A hybrid vehicle driving system 10 according to an embodiment of the invention is, as shown, for example, in FIG. 1, made up of an internal combustion engine 11 and a motor 12, which constitute drive sources of a hybrid vehicle, and a magnet pole position sensor 13.

This hybrid vehicle is such that for example, the internal combustion engine 11, the motor 12 and a transmission T are direct connected in series. Driving force of both the internal combustion engine 11 and the motor 12 is transmitted from the transmission T such as an automatic transmission (AT) or manual transmission (MT) to left and right drive wheels (front wheels or rear wheels) of the vehicle via a differential (not shown) which distributes driving force transmitted thereto between the drive wheels. In addition, when driving force is transmitted from the drive wheels side to the motor side when the hybrid vehicle is decelerated, the motor functions as a generator to produce so-called regenerative braking force so as to recover the kinetic energy of a body of the vehicle as electrical energy. Furthermore, the motor 12 is driven as a generator by output from the internal combustion engine 11 to thereby produce power generating energy.

The motor 12 is a brushless motor which includes, for example, a rotor 21 having permanent magnets 21a and a stator 22 having a stator winding 22a of a plurality of phases which produces a rotary field which rotates the rotor 21, and one end of the motor 12 in a rotational axis 0 direction of the rotor 21 is coupled to a crankshaft 23 of the internal combustion engine 11, whereas the other end thereof is coupled to a front cover 25 of the transmission T via a drive plate 24, whereby driving force of either of the internal combustion engine 11 and the motor 12 which are direct coupled together in series is designed to be transmitted to drive wheels (not shown) of the vehicle via the transmission T.

The rotor 21 is made up of a circular pillar-like rotor iron core 21b which is made up of stacked electromagnetic steel plates and the permanent magnets 21a which are disposed circumferentially at predetermined intervals on an outer circumferential portion of the rotor iron core 21b.

In addition, a plurality of through holes 21c, . . . , 21c are provided circumferentially on an inner circumferential portion of the rotor iron core 21b at positions which are radially outwardly spaced apart a predetermined distance from the rotational axis Q in such a manner as to pass through the inner circumferential portion of the rotor iron core 21b. Furthermore, a plurality of bolt mounting holes 21d, . . . , 21d are provided circumferentially on an end face of the inner circumferential portion of the rotor iron core 21b which lies to the transmission T at positions which are radially outwardly spaced apart a predetermined distance from the rotational axis Q and which do not interfere with the through holes 21c, . . . , 21c.

The stator 22 is formed into a substantially cylindrical shape so as to be disposed in such a manner as to face an outer circumferential surface of the rotor 21 and is fixed by a substantially cylindrical stator holding ring 22b which is fixed to a motor housing 12a. This stator 22 is made up of a stator iron core which is made up of a plurality of stacked electromagnetic steel plates each including a back yoke portion 22c which is formed into an annular shape and a tee portion 22e which extends radially inwardly from the back yoke portion 22c and the stator windings 22a which are wound around the respective tee portions 22d via bobbins 22e.

In addition, fastening holes 23a are provided on an end face of the crankshaft 23 of the internal combustion engine 11 which lies to the motor 12 in such a manner as to face to communicate, respectively, with the through holes 21c provided on the rotor iron core 21b of the rotor 21.

Additionally, the drive plate 24 is formed into substantially a multi-staged cylindrical shape which includes an outer circumferential portion which is coupled to an outer circumferential portion of the front cover 25 of the transmission T by means of fastening members such as rivets and bolts and an inner circumferential portion which protrudes towards the internal combustion engine 11 side along the rotational axis Q from the outer circumferential portion via bent portions.

Furthermore, fastening holes 24a are provided on the inner circumferential portion of the drive plate 24 in such a manner as to face to communicate, respectively, with the bolt mounting holes 21d provided on the rotor iron core 21b, and the inner circumferential portion is brought into surface contact with the end face of the rotor iron core 21b which lies to the transmission T in a direction along the rotational axis Q.

In addition, for example, fastening members 26 such as rivets and bolts are sequentially mounted in the fastening holes 24a on the inner circumferential portion of the drive plate 24 and the bolt mounting holes 21d on the rotor iron core 21b, whereby the drive plate 24 is fixed to the rotor iron core 21b.

Additionally, for example, fastening members 27 such as rivets and bolts are sequentially mounted in the through holes 21c in the rotor iron core 21b and the fastening holes 23a on the crankshaft 23, whereby the rotor iron core 21b is fixed to the crankshaft 23.

Furthermore, for example, as the crankshaft 23 is rotatably supported via appropriate bearings such as ball bearings, the rotor 21 coupled to the crankshaft 23 is allowed to rotate.

The magnet pole position sensor 13, which is made up of, for example, a resolver, is configured to include a resolver rotor 31 and a resolver stator 32, and the annular resolver rotor 31 is mounted in such a manner that an inner circumferential surface of the resolver rotor 31 is brought into abutment with an outer circumferential surface of a mount portion 21e of the rotor 21 where the rotor 21 is fixed to the crankshaft 23, while the annular resolver stator 32, which has an inner circumferential portion which is disposed to face an outer circumferential portion of the resolver rotor 31, is fixed to a cylinder block 11a via a holding frame 33.

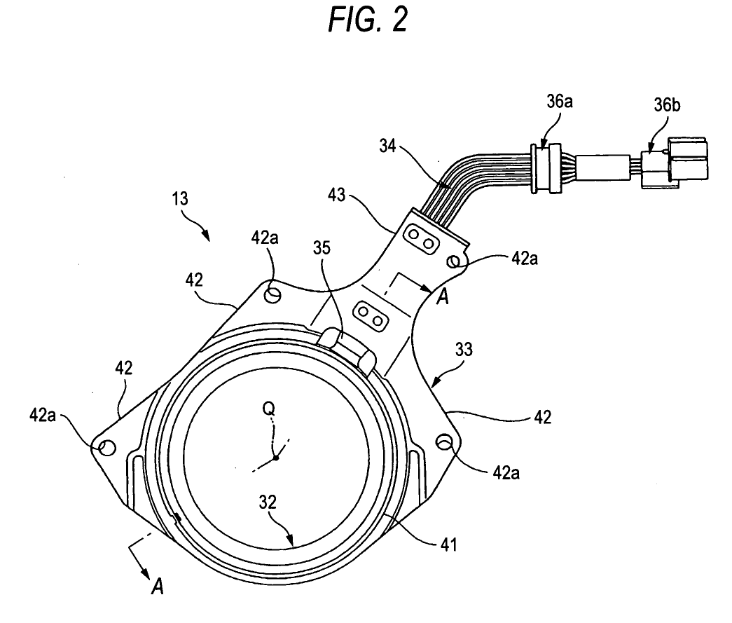

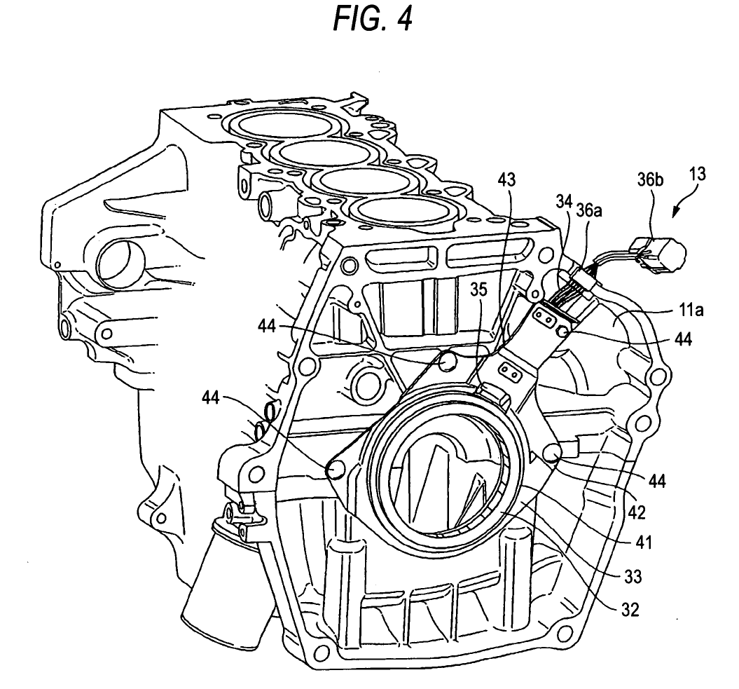

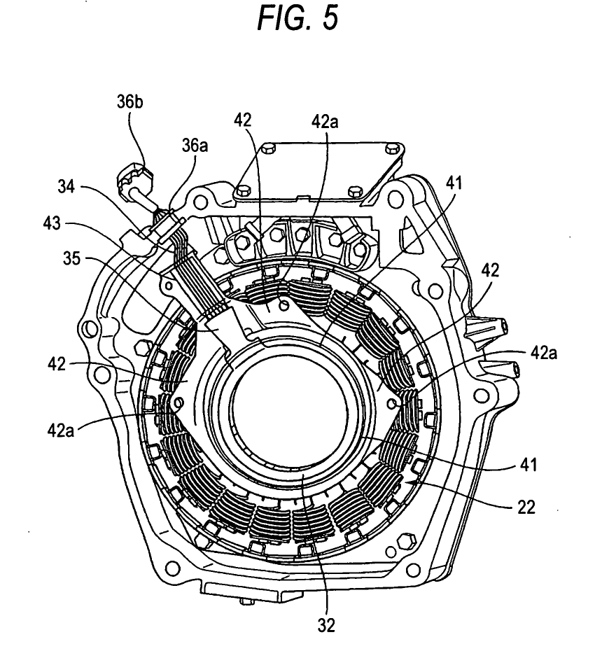

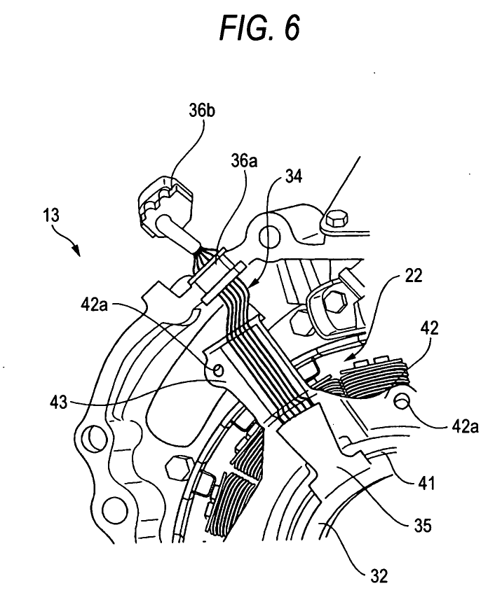

In addition, the resolver stator 32 includes a primary winding into which a reference signal of a sine wave, for example, is inputted and two secondary windings which are disposed in such a manner that a phase difference between the two windings becomes 90° and from which detection signals are outputted in accordance with a rotational angle (that is, a rotor angle θ) of the resolver rotor 31, and two harnesses 34, 34 are connected to each of the windings, that is, six harnesses 34, . . . , 34 in total are connected to the resolver stator 32 via a connector portion 35, as shown, for example, in FIGS. 2 to 6. In addition, as shown, for example, in FIG. 2, these harnesses 34, . . . , 34 can be connected to an outside control unit (not shown) via a grommet 36a and a coupler 36b.

The holding frame 33 is made of an electromagnetic shielding material such as iron and is made up of a substantially annular frame main body 41 in which the resolver stator 32 is installed, a flange portion 42 where bolt mounting holes 42a are provided in such a manner as to face to communicate with corresponding bolt mounting holes on the cylinder block 11a, and an extending portion 43 which extends radially outwardly from the frame main body 41 in such a manner as to follow a laying path of the harnesses 34, . . . , 34 and on which a bolt mounting hole 42a is provided in such a manner as to face to communicate with a corresponding bolt mounting hole on the cylinder block 11a.

In addition, fastening members 44 such as bolts are sequentially mounted in the respective bolt mounting holes of the flange portion 42 and the extending portion 43 and the bolt mounting portions of the cylinder block 11a, whereby the holding frame 33 is fixed to the cylinder block 11a, and the holding frame 33 is set so as to have the same electric potential as that of the cylinder block 11a.

The extending portion 43 of the holding frame 33 is disposed in such a manner as to be interposed between the harnesses 34 and the connector portion 35 of the resolver stator 32 and the stator windings 22a of the stator 22 of the motor 12 in such a state that the internal combustion engine 11 and the motor 12 are direct connected to each other in series, so as to electromagnetically shield the harnesses 34 and the connector portion 35 when the stator windings 22a are energized.

In addition, a stator cover 45 is provided on the resolver stator 32 in such a manner as not only to cover both end faces of the resolver stator 32 in the rotational axis Q direction but also to accommodate the primary winding and the secondary windings in an interior thereof.

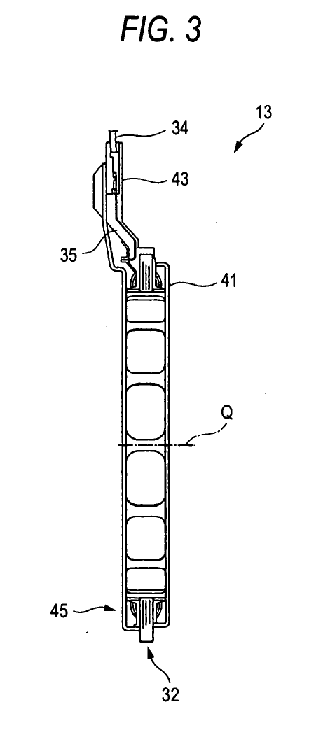

Additionally, the resolver stator 32 and the resolver rotor 31 are disposed in such a manner as to overlap each other in a direction along the rotational axis Q at inner circumferential side coil ends of the stator windings 22a on an internal combustion engine 11 side thereof, so that the magnet pole position sensor 13 can be made thinner in the direction along the rotational axis Q to thereby reduce a dimension in the axial direction. Due to this, as shown, for example, in FIGS. 1 and 3, the holding frame 33 (for example, the extending portion 43) is bent in the direction along the rotational axis Q at the inner circumferential side coil ends of the stator windings 22a.

The hybrid vehicle driving system 10 according to the embodiment of the invention is configured as has been described heretofore, and next, a method for fabricating the hybrid vehicle driving system 10 will be described.

When fixing the internal combustion engine 11, the motor 12 and the magnet pole position sensor 13 which make up the hybrid vehicle driving system 10, firstly, the resolver stator 32 is installed in the holding frame 33, and next, the fastening members 44 are sequentially installed in the bolt mounting holes 42a on the flange portion 42 and the extending portion 43 and the bolt mounting holes of the cylinder block 11a, so as to fix the holding frame 33 to the cylinder block 11a.

Then, the stator 22 of the motor 12 is installed in the stator holding ring 22b, and the stator holding frame 22b is fixed to the motor housing 12a. Following this, the motor housing 12a is fixed to the cylinder block 11a by means of the fastening members such as bolts in such a manner that the magnet pole position sensor 13 and the holding frame 33 are held from both the sides by the cylinder block 11a and the stator 21 and that the extending portion 43 is interposed between the harnesses 34 of the magnet pole position sensor 13 and the stator windings 22a of the stator 22.

Then, the resolver rotor 31 is mounted on the mount portion 21e of the rotor 21 of the motor 12 where the rotor 21 is fixed to the crankshaft 23, and next, the fastening members 27 are sequentially mounted in the through holes 21c in the rotor iron core 21b and the fastening holes 23a on the crankshaft 23, so as to fix the rotor 21 to the crankshaft 23.

Thus, as has been described heretofore, according to the hybrid vehicle driving system 10 and the method for fabricating the hybrid vehicle driving system 10 of the embodiment of the invention, while suppressing an increase in the number of components required to make up the driving system and preventing the spending of many labor hours for complex and troublesome work when fabricating the system, the harnesses 34 of the magnet pole position sensor 13 can be protected physically and an electromagnetic shielding can be implemented on the harnesses 34 of the magnet pole position sensor 13 when the stator windings 22a of the motor 12 are energized.

Moreover, the holding frame 33 can be set so as to have the same electric potential as that of the cylinder block 11a, and the holding frame 33 is grounded due to, for example, a vehicle body on which the cylinder block 11a is installed being grounded.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

I/We claim:

1. A hybrid vehicle driving system comprising:
a motor including a rotor which is disposed between an internal combustion engine and a transmission to be connected to them;
a magnet pole position sensor disposed between the internal combustion engine and the motor, for detecting a magnet pole position of the rotor;
a holding member made of an electromagnetic shielding material, for holding the magnet pole position sensor; and
an extending portion which extends from the holding member in such a manner as to be interposed between a connection wiring of the magnet pole position sensor and a stator winding of the rotor.

2. A hybrid vehicle driving system as set forth in claim 1, wherein the holding member includes a plurality of fastening portions which are fastened to be fixed to a main body of the internal combustion engine.

3. A method for fabricating a hybrid vehicle driving system which comprises a motor comprising a rotor which is disposed between an internal combustion engine and a transmission to be connected to them and a magnet pole position sensor for detecting a magnet pole position of the rotor, said method comprising the steps of:
fixing a holding member made of an electromagnetic shielding material for holding the magnet pole position sensor to a main body of an internal combustion engine; and
fixing a motor housing which accommodates the motor in an interior thereof to the main body of the internal combustion engine in such a manner that the magnet pole position sensor and the holding member are held from both sides by the internal combustion engine main body and the motor and that an extending portion which extends from the holding member is interposed between a connection wiring of the magnet pole position sensor and a stator winding of the rotor.
